(19) United States
(12) Patent Application Publication
(10) Pub. No.: US 2017/0369104 A1
(43) Pub. Date: Dec. 28, 2017

(54) INSTRUMENT CARRIER OF A MOTOR VEHICLE AND MOTOR VEHICLE

(71) Applicant: GM GLOBAL TECHNOLOGY OPERATIONS LLC, Detroit, MI (US)

(72) Inventor: Stephan RUCHNEWITZ, Ruesselsheim (DE)

(73) Assignee: GM GLOBAL TECHNOLOGY OPERATIONS LLC, Detroit, MI (US)

(21) Appl. No.: 15/629,348

(22) Filed: Jun. 21, 2017

(30) Foreign Application Priority Data
Jun. 24, 2016 (DE) 102016007780.8

(51) Int. Cl. B62D 25/14; B60K 37/02

(52) U.S. Cl. CPC B62D 25/145; B60K 37/02; B60K 2350/943; B60K 2350/302

(57) ABSTRACT

An instrument carrier of a motor vehicle includes at least one hollow space lying in an end region transversely to the driving direction. The hollow space has an inner surface forming a slide-in contour. A housing is arranged in the hollow space, which contains a vehicle component.

### CROSS-REFERENCE TO RELATED APPLICATION

This application claims priority to German Patent Application No 102016007780.8, filed Jun. 24, 2016, which is incorporated herein by reference in its entirety.

### TECHNICAL FIELD

The present disclosure pertains to an instrument carrier of a motor vehicle and a corresponding motor vehicle.

### BACKGROUND

Modern motor vehicles include a plurality of components and units. In particular, the number of the electrical and electronic components has risen greatly in the past because of the increasing complexity. Many motor vehicles are equipped with a substantially greater number of control devices than earlier motor vehicles. The control devices are required for realizing a wide range of newer functions and assistance systems. This increase in control devices constitutes a challenge in an effort to optimize the installation space.

DE 10 2004 056 102 A1 discloses a component including a shell-like basic carrier and at least one core element. The basic carrier includes at least one closing seam and is connected to the core element via at least one tolerance-offsetting intermediate layer. Additionally, electrical lines, conductor paths, glass fiber cables, sensors, strain gauges and/or electronic chips can be provided which are introduced into a hollow space formed between the core element and the basic carrier. Basic carrier and core element form a sturdy component in light-weight construction. The component can be employed for example as instrument panel carrier.

Disadvantageous with this component is that for the introduced additional elements only minimal installation space can be made available, since these have to be introduced between basic carrier and core element. Since the core element contributes to the sturdiness of the basic carrier, the installation space that is made available cannot be any size. In addition, an electrical component in such a hollow space is exposed to mechanical stresses which contributes to early wear. Accordingly, there is a need for further development an instrument carrier and a motor vehicle so that stowage components of the motor vehicle are provided.

### SUMMARY

In accordance with the present disclosure, an instrument carrier of a motor vehicle is described. The instrument carrier has a hollow space lying in an end region transversely to the travelling direction, which includes an inner surface forming a slide-in contour. A housing is arranged in the hollow space and is configured to contain a vehicle component.

Because of its function, the carrying of an instrument panel and mostly the stiffening of the body, the instrument carrier is relatively large in volume. This volume is used for receiving at least one vehicle component, as a result of which the packing density in the motor vehicle can be increased and the space utilization improved. Through the arrangement in a housing, which lies in the hollow space of the instrument carrier, the corresponding vehicle is well protected.

In a further configuration, the housing may include an outer surface that is adapted to the slide-in contour, so that the housing sits in the hollow space with minimum play or without play so that in driving mode noises through the movement of the housing relative to the hollow space can be avoided and at the same time the mechanical stress on the vehicle component in the housing is reduced.

In another further configuration, the vehicle component can be a fluid reservoir. The fluid reservoir can be in particular a windscreen wiper water reservoir. The instrument carrier is frequently arranged spatially in the vicinity of a windscreen of the motor vehicle so that by providing the fluid reservoir, in particular wiper water reservoir, in the instrument carrier storage of wiper water near the windscreen is made possible. As a result, space can be saved in the engine compartment and short line distances are possible. In addition, freezing of the fluid in winter is less probable since the instrument carrier is heated through the passenger compartment of the motor vehicle. The arrangement increases the maintenance friendliness and facilitates positioning of the remaining components and units in the engine compartment.

In another further configuration, the vehicle component can be a circuit board. On the circuit board, electrical and electronic components as well as connections can be arranged. The circuit board can form a module, in particular a control module. As a result, electrical components can be introduced into the instrument carrier.

In another further configuration, both end regions arranged transversely to the driving direction (i.e., left and right) can form corresponding hollow spaces and receive housings. Both housings can serve for storing fluid reservoirs or circuit boards. Alternately, one housing can be provided for a fluid reservoir and the other housing for one or more circuit boards.

In another further configuration, the housing may include a retaining structure for the vehicle component. As a result, the vehicle component can be securely arranged in the housing.

In a further configuration, the housing may include a retaining structure for a further vehicle component. As a result, the space utilization in the housing can be optimized. For example, two circuit boards can be arranged back to back to one another.

In another further configuration, the housing can include a passage opening. As a result, an access to the vehicle component can be brought about. Depending on configuration, a fluid line or a cable or a cable harness can be fed through the passage opening.

In another further configuration, the instrument carrier may include at least one opening arranged circumferentially. As a result, the vehicle component can be reached from the outside through the instrument carrier. In particular, the opening may be arranged in the instrument carrier and the passage opening be arranged in the housing in an overlapping manner.

In another further configuration, an interface may be arranged on the housing. As a result, a contact to the vehicle component arranged in the interior of the housing can be realized from the outside.

In another further configuration, the hollow space may be cylindrical. This facilitates introducing the housing into the hollow space.

In another further configuration, the instrument carrier may include a stop for the housing. As a result, the slide-in depth of the housing can be defined. A suitable stop can for example be stated by one or a plurality of projections.

In another further configuration, the hollow space may have a substantially closed circumferential surface. As a result, the hollow space can serve for structural stiffening. An exception in some configurations may be provided by the at least one previously described opening.

A first independent subject relates to a motor vehicle with an instrument carrier of the previously described type. A corresponding motor vehicle has a higher installation space density than conventional motor vehicles.

In a first further configuration of the motor vehicle, a face end of the instrument carrier is arranged in the opening region of a door of the motor vehicle. As a result, easy access to the housing and thereby to the vehicle component located in the interior of the housing can be made possible as a result of which a repair and maintenance are facilitated.

Another further aspect provides an instrument panel which has an opening in the region of the face end of the instrument carrier and a cover for closing the opening. In this way, an aesthetic appearance free of interruption of the instrument panel can be achieved.

### BRIEF DESCRIPTION OF THE DRAWINGS

The present disclosure will hereinafter be described in conjunction with the following drawing figures, wherein like numerals denote like elements.

FIG. 1 is a lateral view of a motor vehicle;

FIG. 2 is a perspective view of an instrument carrier;

FIG. 3 is a cross section through an instrument carrier in a first configuration; and

FIG. 4 is a cross section through an instrument carrier in a second configuration.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

FIG. 1 shows a lateral view of a motor vehicle 2. The motor vehicle 2 includes a front door 4 which allows a driver to enter. The front door 4 defines an opening region 6 (framed in dashed line). The opening region 6 is the region which is accessible from the outside with the front door 4 opened. The motor vehicle 2 includes an instrument panel 8 (shown in dashed line), which carries instruments and control elements. The instrument panel 8 ends with a lateral surface 8.1 towards the front door 4 provided the latter is in the closed state.

The instrument panel 8 includes an opening 8.2. On the lateral surface 8.1 of the instrument panel 8 a removable cover 10 for the opening 8.2 is provided. The cover 10 is located in the opening region 6 of the front door 4. The instrument panel 8 is held by an instrument carrier 12 the face end 12.1 of which is arranged behind the cover 10. As a result, the instrument carrier 12 can be reached through the opened or removed cover 10.

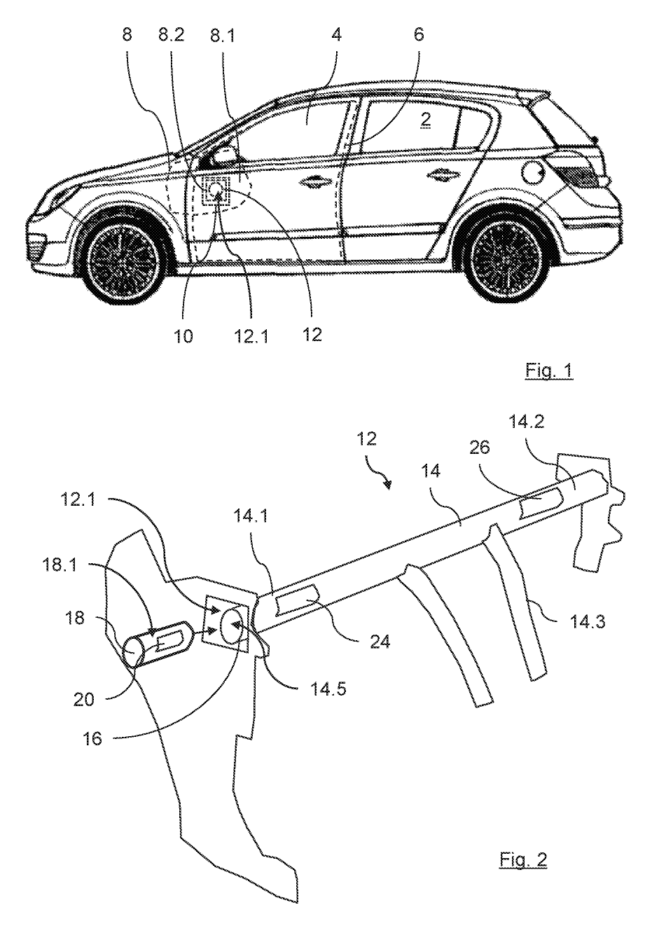

FIG. 2 shows a schematic perspective view of the instrument carrier. The instrument carrier 12 includes a cross brace 14. The cross brace 14 is formed substantially cylindrically and likewise includes cylindrical end regions 14.1, 14.2 which form a hollow space 16. On the cross brace 14, fastening structures 14.3 for the instrument panel 8 and fastening structures 14.4 for fixing the instrument carrier 12 in the motor vehicle 2 are additionally provided. The hollow space 16 is defined by an inner surface 14.5 of the cross brace 14. The end regions 14.1, 14.2 have a substantially closed circumferential surface 14.6.

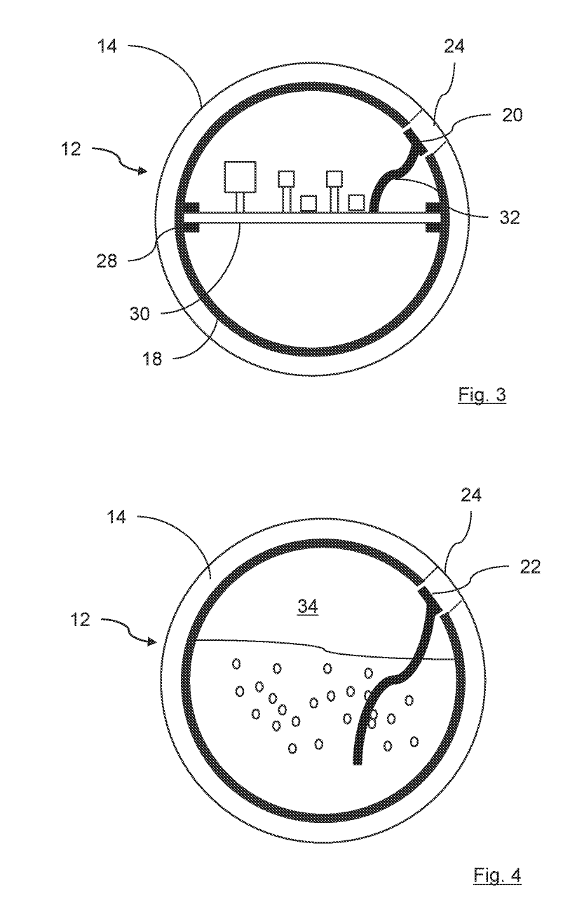

By way of the face end 12.1, a housing 18 can be slid into the end region 14.1. The housing 18 can accommodate a vehicle component shown in the FIG. 3a, 3b. The housing 18 includes an outer surface 18.1 which with respect to shape and dimension is adapted to the inner surface 14.5 of the instrument carrier 12.

In the interior, the cross brace 14 includes a non-visible stop for delimiting the slide-in depth of the housing 18. The housing 18 includes a connection 20. In the appropriate places in the cross brace 14, openings 24, 26 are provided, through which the connection 20 is accessible. The connection 20 can be an electrical connection, hydraulic connection, pneumatic connection or another type of connection.

FIG. 3 shows a cross section through the instrument carrier 12 in a first configuration with slid-in housing 18. The housing 18 sits within the cross brace 14 free of play. In the interior, the housing includes a retaining structure 28 for fixing a circuit board 30. The circuit board 30 can represent a control for a motor vehicle function. The circuit board 30 is connected to the electrical connection 20 via a cable 30. In some configurations, a further circuit board can be additionally provided, which uses up the lower half of the hollow space available within the housing. Other configurations with a plurality of circuit boards are also conceivable. Corresponding controls can be provided for example for parking assistance, safety functions and the like.

FIG. 4 shows an alternative configuration of an instrument carrier 12, in the case of which a reservoir 34, for example a windscreen wiper water reservoir is provided with the housing 18. In this case, a line feed-through or a water connection can be provided instead of an electrical connection 20.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. An instrument carrier of a motor vehicle comprising
at least one hollow space lying in an end region transversely to the driving direction having an inner surface forming a slide-in contour;
a housing arranged in the hollow space and configured to contain a vehicle component.

17. The instrument carrier according to claim 16, wherein the housing comprises an outer surface configured to the slide-in contour.

18. The instrument carrier according to claim 16, wherein the vehicle component is a fluid reservoir.

19. The instrument carrier according to claim 16, wherein the vehicle component is a circuit board.

20. The instrument carrier according to claim 16, wherein the housing comprises a retaining structure for the vehicle component.

21. The instrument carrier according to claim 20, wherein the housing comprises a retaining structure for an additional vehicle component.

22. The instrument carrier according to claim 16, wherein the housing comprises a passage opening.

23. The instrument carrier according to claim 16, wherein the instrument carrier comprises at least one opening arranged on a circumferential side thereof.

24. The instrument carrier according to claim 16, further comprising an interface arranged on the housing.

25. The instrument carrier according to claim 16, wherein the hollow space is cylindrical.

26. The instrument carrier according to claim 16, wherein the instrument carrier comprises a stop for the housing.

27. The instrument carrier according to claim 16, wherein the hollow space defines a closed circumferential surface.

28. A motor vehicle comprising a vehicle body having an instrument carrier according to claim 16 extending transversely in the vehicle body.

29. The motor vehicle according to claim 28, wherein the instrument carrier further comprises a face end arranged in a door opening region of the motor vehicle.

30. The motor vehicle according to claim 29, further comprising an instrument panel having an opening in the region of the face end of the instrument carrier and a cover for closing the opening.
